(19) United States
(12) Patent Application Publication
(10) Pub. No.: US 2009/0089005 A1
(43) Pub. Date: Apr. 2, 2009

(54) GENERATION OF TEST SPECIFICATIONS BASED ON MEASURED DATA POINTS

(76) Inventors: Geoff Hopcraft, Santa Rosa, CA (US); Joseph M. Gorin, Santa Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/863,924

(22) Filed: Sep. 28, 2007

(51) Int. Cl. G06F 19/00

(52) U.S. Cl. 702/123; 702/127

(57) ABSTRACT

Autonomous or machine generation of test specifications can be achieved by capturing the measured test data of a device and then using the captured test data to build a test specification, such as a limit line, for subsequent testing of similar devices. The generated test specification is typically adapted for use with respect to limited resources, such as through use of a piece-wise linear configuration. In an embodiment, the number of piece-wise linear portions of the generated test specification is minimized or otherwise optimized. In embodiments, the generated test specification is adjusted to accommodate expected measurement variation, such as thermal noise, device process variation, random jitter, etc., and, if desired, adjusted to allow for changes in test accuracy of subsequent tests. In one embodiment, one or more test measurement inaccuracies are eliminated in the construction of the limit line.

### TECHNICAL FIELD

This disclosure relates to test specification generation and more specifically to systems and methods for building a test specification limit line based upon measured data taken from a sample device.

### BACKGROUND OF TILE INVENTION

It is common that when a device is being tested the resultant measured data is compared against a test specification to determine if the device is performing, properly. For example, a test specification may be established which defines one or more test limit wherein tested devices having measured test data falling below or above, as the case may be, the test limit may be considered acceptable.

A test specification used in determining the acceptability of a device under test (DUT) may be relatively complex. For example where operation of a device with respect to an input variable (independent variable or input testing stimuli) over a range and an output variable dependent therefrom (dependent variable) is tested over an operating range of the input variable, the test limit is not a single value but a plurality of values. In a situation, for example, when a dependant variable (such as output voltage or power) is measured as a function of an independent variable (such as frequency), the value of the expected measured data varies with the applied input testing stimuli. Thus, a test specification used in determining whether the dependent variable for a particular DUT falls within an acceptable range for a variable input testing stimuli is not a single value but rather a plurality of different values. The values setting forth a test specification can be thought of as a limit line. Such a limit line provides a measure of whether a DUT is acceptable or not, and may be provided as maximum acceptable values, minimum acceptable values, or a combination thereof (e.g., a tolerance envelope defined by maximum acceptable values and minimum acceptable values).

The test characteristics (e.g., measured test data) of one or more known “good” devices can be used to derive a test limit for testing of subsequent devices. Likewise, a device may serve as its own “good” device in that its performance at any given point in time is compared against a test limit derived from that same device at an earlier point in time. However, establishing a limit line which provides useful acceptance/rejection of DUTs is more complicated than simply testing a device and directly establishing a limit line from the results. Noise, such as thermal noise, and noise-like results, such as may result from device manufacturing process variations or differences in testing conditions over time, introduce variations in the operating performance of the different devices. A limit line which is to minimize false negatives (i.e., false indications that a DUT is not performing as desired) and false positives (i.e., false indications that a DUT is performing as desired) should account for such insignificant variations, while being adapted to detect significant differences in operation due to fundamental DUT characteristics. Accordingly, establishing a useful limit line is not as simple as testing a device and extrapolating a limit line therefrom.

There are various techniques in use today for determining limit lines which attempt to accommodate the foregoing variations. One method for determining a limit line used today is to empirically measure the responses of a device (e.g., a known good or “golden” device) over a range of input testing stimuli and a range of operating conditions. Additionally or alternatively, a plurality of such devices may be tested over the range of input testing stimuli and/or a range of operating conditions. Accordingly, not only may different devices be tested in order to provide statistically relevant data, but various testing parameters, such as ambient temperature, may be varied to improve the statistical relevance of the data. The foregoing tests provide a plurality of input stimuli to output response data sets (also referred to herein as “test traces” or “traces”). The resulting data sets are then analyzed statistically, such as to determine a standard deviation of the test results, to thereby provide statistical limit information from which to derive a limit line. Such a testing method requires appreciable time to conduct testing of multiple devices and compile data therefrom. Likewise, appreciable time and computational power is required to compile the statistical data. Moreover, creating a limit line (which is generally quite complex), and implementing the limit line in an instrument or other test facility used for testing, based upon the resulting data sets provided by such a method typically require substantial effort to extract the data, create one or more database of limit line data, manipulate the limit line data for use by a selected instrument, and import the information into the instrument.

Another method for determining a limit line used today is to calculate theoretical acceptable limits and set the limit line based on these calculations. For example, simulations of device behavior may be made, such as using Monte Carlo methods, to predict variations in operation of a device associated with noise (e.g., thermal noise) and noise-like behavior (e.g., variations in test conditions) and thus provide a plurality of simulated input stimuli to output response data sets (also referred to herein as “simulated traces” or “traces”). As with the testing method discussed above, the resulting data sets are then analyzed statistically to thereby provide statistical limit information from which to derive a limit line. Such simulations are generally time consuming and require appreciable computational power. As with the testing method discussed above, the statistical analysis applied to the data sets to derive a limit line require appreciable time and computational power. Moreover, the data sets provided thereby may not accurately reflect actual operational results, such as due to erroneous assumptions etc. Additionally, creating a limit line (which is generally quite complex), and implementing the limit line in an instrument used for testing, based upon the resulting data sets provided by such a method typically require substantial effort to extract the data, create one or more database of limit line data, manipulate the limit line data for use by a selected instrument, and importing the information into the instrument.

Although computationally complex and relatively time consuming and difficult to implement in an instrument, the foregoing methods have been generally preferred due to their approaches resulting in a limit line which is less likely to provide false negatives and false positives due to slight differences in measured results. That is, limit lines derived by the foregoing techniques are adapted to accommodate differences in operation due to noise or noise-like results, such as due thermal noise and/or due to differences in operating conditions, which are not significant to the determination of acceptability of the DUT, while detecting significant differences in operation due to fundamental DUT characteristics. Accordingly, the generally computationally intensive and time consuming process of either simulating or empirically testing a device in different test conditions and/or simulating or empirically testing multiple devices is widely believed to be necessary to provide limit lines which do not result in excessively large numbers of DUTs being rejected due to noise and noise-like responses.

Available as an alternative to the foregoing statistical based testing and simulation methods, many existing test facilities (e.g., instruments and/or supporting software) allow a user to specify the independent and dependent parameters of a limit line, such as by using a graphical user interface (GUI) or by using numerical data entry. Thus, users who wish to build a test specification, such as a limit line, from empirical measurements of a device may examine the measured test data and then manually decide on limit line parameters which encapsulate the measurement results. Not only does this process can take a significant amount of time, but the resulting limit line is susceptible to transcription and other errors. Moreover, a user is often unable to accurately predict the variations in the test results which are insignificant to a determination as to whether a DUT is performing as desired. Accordingly, such limit lines are prone to provide false negatives and/or false positives.

### BRIEF SUMMARY OF THE INVENTION

Embodiments of the present invention provide for generation of test specifications, such as may provide a limit line, which are adapted to accommodate expected measurement variations using a single input stimuli to output response data set (also referred to herein as a “trace”). A data set utilized in generation of test specifications is typically provided by capturing the measured data of a device, such as a known good or “golden” device, representative of the devices to be tested. However, embodiments of the present invention may generate test specifications using a data set provided through simulation or other means.

A data set utilized in generation of test specifications according to embodiments of the invention comprises at least one independent variable (e.g., independent input stimuli) and at least one dependent variable (e.g., output response dependent upon the input stimuli). That is, embodiments of the present invention typically provide test specifications from a single data set, wherein the data set provides at least a two dimensional data compilation. Adjacent data points along at least one axis of such an at least two dimensional data compilation are typically utilized in adapting the generated test specifications to accommodate expected measurement variations in subsequent testing.

According to a preferred embodiment of the invention, variations and/or trends between data points of a data set are utilized to adapt a generated test specification to accommodate variations in testing, such as may be associated with noise or noise-like results. For example, a function based upon an amount of jitter or random variation present between adjacent data points in a data set or present with respect to a set of data points in a data set may be used to establish an acceptable difference, or threshold value, between a trace and a limit line generated using the trace which accommodates expected measurement variations, such as due to noise or noise-like results, which are not significant to the determination of acceptability of the DUT, while providing a limit line useful in detecting significant differences in operation due to fundamental DUT characteristics.

Embodiments of the invention operate to capture measured test data of a device and generate a test specification therefrom through autonomous operation of a test specification generation method. For example, an instruction set operable to provide test specification generation according to the present invention may be provided within a spectrum analyzer, an oscilloscope, a network analyzer, or other an instrument or other test facility, so as not only provide machine or autonomous generation of test specifications but to provide an instrument configuration which provides testing of devices using an internally generated test specification.

Test specifications generated according to embodiments of the present invention are typically adapted to minimize or optimize the use resources in implementing the test specifications. Embodiments of the invention, as discussed above, utilize a single data set or trace in providing a test specification or limit line, thereby reducing or minimizing the resources needed in the generation of the test specification. A data set or trace utilized in providing a test specification or limit line according to embodiments of the invention may be generated using a single data set or trace derived from one input stimuli to output response test or derived from multiple input stimuli to output response tests. For example, multiple “known good” traces may be consolidated into a single input testing stimuli to output response data set or trace, such as by selecting the maximum value from all of these traces at each corresponding data point or bucket (e.g., applying a “maximum hold” method), used in generating a test specification or limit line.

Additionally or alternatively, to facilitate reduced utilization of memory and processing resources, test specifications generated according to embodiments of the invention are piece-wise linear (e.g., when associated with a two dimensional test data set) or piece-wise planar (e.g., when associated with a three dimensional test data set), although other contours may be utilized according to embodiments of the invention. A difference, or threshold value, between the test specification and corresponding trace for each piece-wise linear portion of such a test specification is typically selected so as to accommodate expected measurement variations, such as due to noise or noise-like results, which are not significant to the determination of acceptability of the DUT, while detecting significant differences in operation due to fundamental DUT characteristics. Embodiments of the invention further operate to reduce or minimize the number of piece-wise portions (e.g., line segments, plane segments, etc.) in the resulting test specification. According to preferred embodiment, a method used in generating the test specification operates to lengthen and/or consolidate piece-wise portions in the test specification after initially generating such piece-wise portions.

The foregoing reduction or minimization of the number of piece-wise portions in a test specification not only facilitates implementation of the test specification in an instrument with limited resources, or otherwise using limited resources, but also facilitates improved usability of the test specification. For example, manual editing of the resulting test specification by a user is simplified as the reduced piece-wise portions of the test specification are more readily selected and adjusted. Although the resulting test specification may be edited using computer based equipment (e.g., personal computer workstation) having a sophisticated and robust user interface, such simplified selection of a desired portion of the test specification (e.g., portion of a limit line) for adjustment will greatly simplify the user's work in editing the specification. Moreover, where the test specification is edited within an instrument, such as an instrument used in generating the test specification and/or applying the test specification to DUTs, such simplified selection of a desired portion of the test specification for adjustment may be particularly useful, such as where the instrument has a limited user interface (e.g., small display, limited input, etc.).

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIGS. 1A and 1B show one embodiment of a test facility adapted in accordance with an embodiment of the invention;

FIG. 2 shows a flow diagram of operation for obtaining a test results data set and generating a test specification using the test results data set;

FIGS. 3A-3C illustrate various points in the generation of a test specification according to an embodiment of the present invention;

FIG. 4 shows a flow diagram of machine generation of a test specification according to an embodiment of the present invention; and

FIG. 5 shows a flow diagram of operation for using a test specification for device acceptance testing according to an embodiment of the invention.

### DETAILED DESCRIPTION OF THE INVENTION

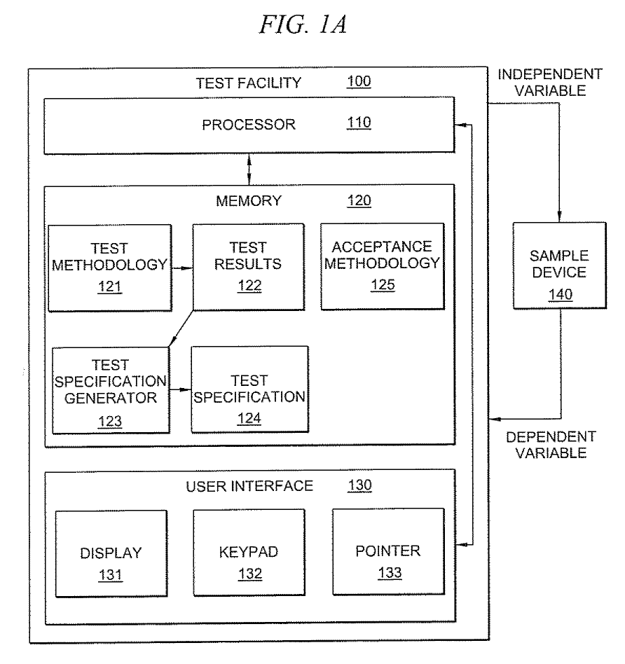

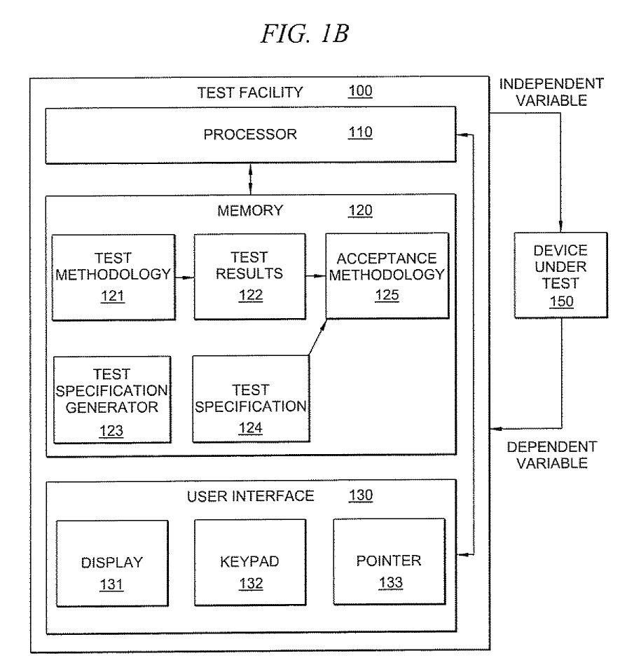

FIGS. 1A and 1B show an instrument or test facility adapted according to an embodiment of the present invention. Test facility 100 of the illustrated embodiment, such as may comprise any number of instruments and instrument configurations (e.g., a spectrum analyzer, an oscilloscope, a network analyzer, and/or the like), includes processor 110, memory 120, and user interface 130. Of course, test facility 100 may include additional functional blocks, such as test signal generation, test response capture, peripheral input/output, report generation, diagnostics, etc. However, to simplify the discussion of test facility 100 in order to facilitate the understanding of the present invention, such additional functional blocks have been omitted from the illustrated embodiment. It should be appreciated that the foregoing functional blocks, as well as additional or alternative functional blocks, my be incorporated in a test facility adapted according to embodiments of the invention. Moreover, test facility 100 may comprise any testing system that measures or displays an output as a function of an input variable.

Processor 110 typically comprises one or more central processing units (CPU), such as a processor from the PENTIUM family of processors available from Intel Corporation or from the POWER family of processors available from the AIM Alliance (Apple Inc., International Business Machines Corp., and Motorola, Inc.), or other general purpose processors operating under control of an instruction set to define operation as described herein. Alternatively, processor 110 may comprise one or more application specific integrated circuits (ASIC) or other uniquely configured processors operating under control of an instruction set to define operation as described herein.

Memory 120 typically comprises one or more of random access memory (RAM), read only memory (ROM), flash memory, non-volatile memory, disk memory, and optical memory suitable for storing control methods and data as described herein. Memory 120 interacts with processor 110 to provide instruction sets and data thereto and to store data provided thereby. Memory 120 of the illustrated embodiment includes test methodology 121, test results 122, test specification generator 123, test specification 124, and acceptance methodology 125, the operation of each of which will be described in detail below.

User interface 10 typically comprises one or more output device, shown here as display 131 which may represent a cathode ray tube (CRT), a liquid crystal display (LCD), a printer, etc., and one or more input device, shown here as keypad 132 which may represent a keyboard, a key switch array, a touch screen, a virtual keyboard, etc. and pointer 133 which may represent a mouse, a trackball, a stylus, a touch pad, etc. User interface 130 may, depending upon the particular instrument represented, be vary robust or may be relatively limited. Generation of test specifications, and the use thereof, according to embodiments of the invention are adapted to accommodate usability with respect to even very limited user interface capabilities.

Test facility 100 provides a platform from which various devices may be tested and/or analyzed, such as to determine if the devices meet an acceptance criteria, are performing as desired, etc. Accordingly, test facility 100 includes an interface for providing signals to and receiving signals from various devices. Specifically, test facility 100 of the illustrated embodiment provides output of a test signal comprising an independent variable of a device test procedure and receives input of a test signal comprising a dependent variable of a device test procedure, wherein the output test signal (output variable or dependent variable) is provided to a device being tested and the input test signal (input testing stimuli or independent variable) is received from the device being tested. Although only a single output test signal and input test signal are shown to simplify the discussion herein, it should be appreciated that a plurality of either or both may be utilized according to embodiments of the invention.

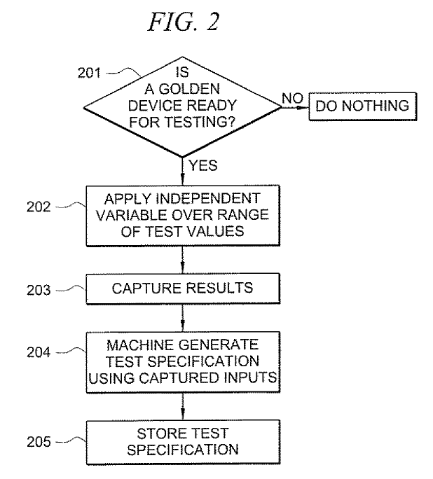

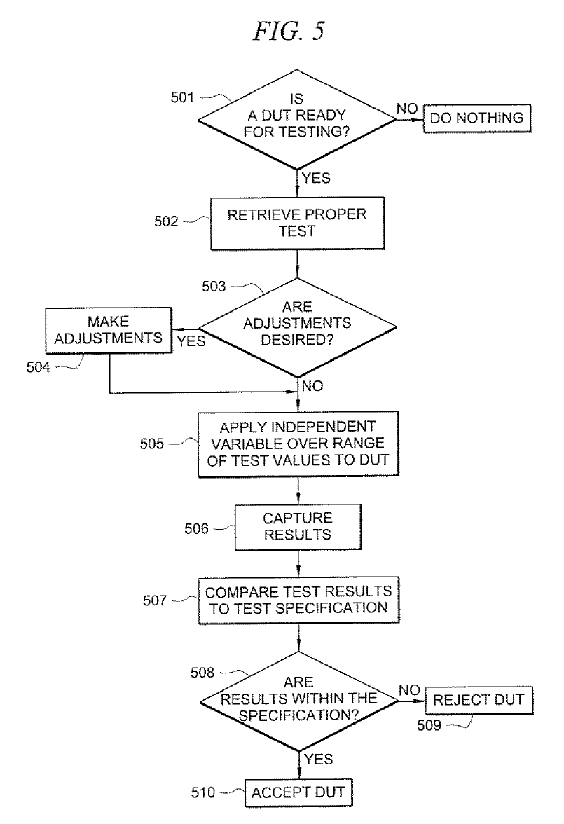

In operation according to a preferred embodiment, test facility 100 performs testing on a sample device (e.g., sample device 140), collects test results from the sample device, uses the sample device test results to generate a test specification, and uses the test specification to test a plurality of devices (e.g., a plurality of DUT 150) for acceptance or other purposes. The flow diagrams of FIGS. 2 and 5 show further detail with respect to the foregoing operation of test facility 100. Specifically, FIG. 2 shows operation of test facility 100 as performed by processor 110 operating under control of control instructions of test methodology 121 and test specification generator 123 while FIG. 5 shows operation of test facility 100 as performed by processor 110 operating under control of control instructions of test methodology 121 and acceptance methodology 125.

Directing attention to FIG. 2, test methodology 121 operable in a sample test mode performs process 201 to determine if a sample device, such as sample device 140, is ready for testing. Sample device 140 typically comprises a device, such as may be a known good or “golden” device or any device expected to have properties that are acceptable, representative of the devices to be tested by test facility 100 for application of acceptance methodology 125. If it is determined at process 201 that no sample device is ready for testing processing may stop (e.g., “do nothing”) or may continue to monitor for a sample device for testing. If it is determined at process 201 that a sample device is ready for testing, processing according to the illustrated embodiment proceeds to process 202.

Process 202 of test methodology 121 causes an output test signal in accordance with test parameters of test methodology 121 to be provided to sample device 140. The output test signal provides a range of at least one independent variable, such as frequency, voltage, current, power, data rate, modulation scheme, noise injection, amplitude, etc., to provoke a range of at least one dependent variable in a corresponding input test signal provided by sample device 140. For example, in the case where test facility 100 comprises a spectrum analyzer, the output test signal may comprise a sweep or series of frequencies selected at various points along a desired frequency spectrum. The different frequencies used in such a test may be spaced so as to allow for meaningful test signal input values, wherein the spacing would depend upon the device and the precision desired of the test specification.

Process 203 of test methodology 121 captures an output of sample device 140 as the input test signal and stores the test results data set in test results 122. In the foregoing example of a spectrum analyzer, the input test signal may comprise a range of power resulting from the sweep or series of frequencies of the output test signal. Accordingly, the input test signal may be represented as a trace of the above mentioned at least one independent variable at different values and the at least one dependent variable at corresponding values.

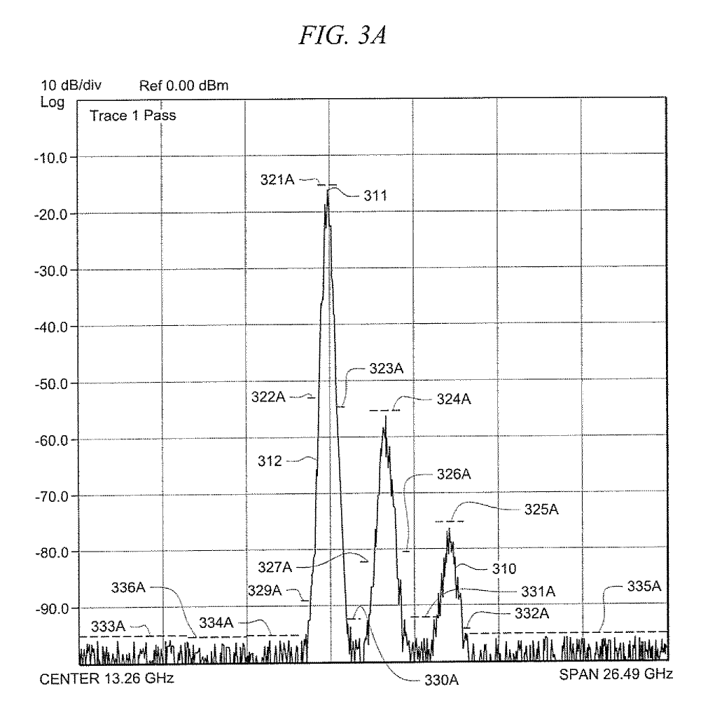

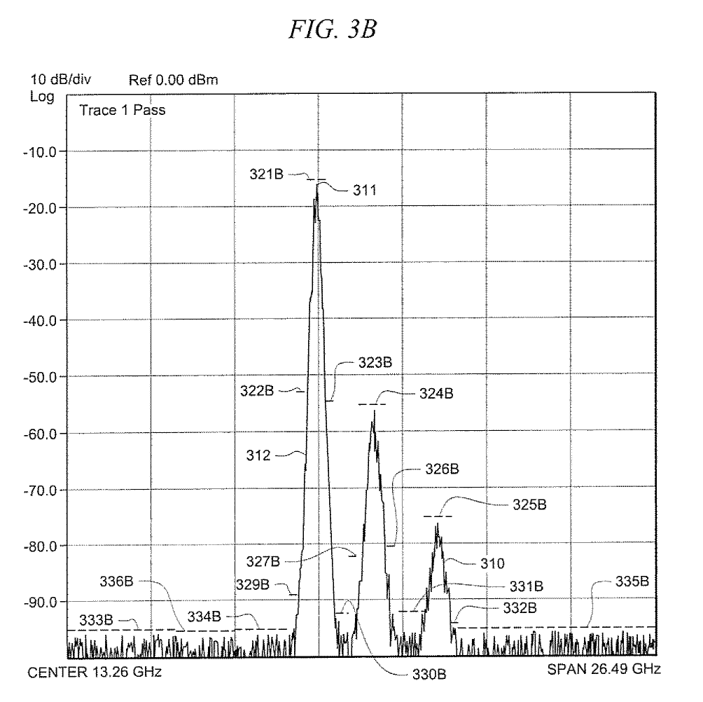

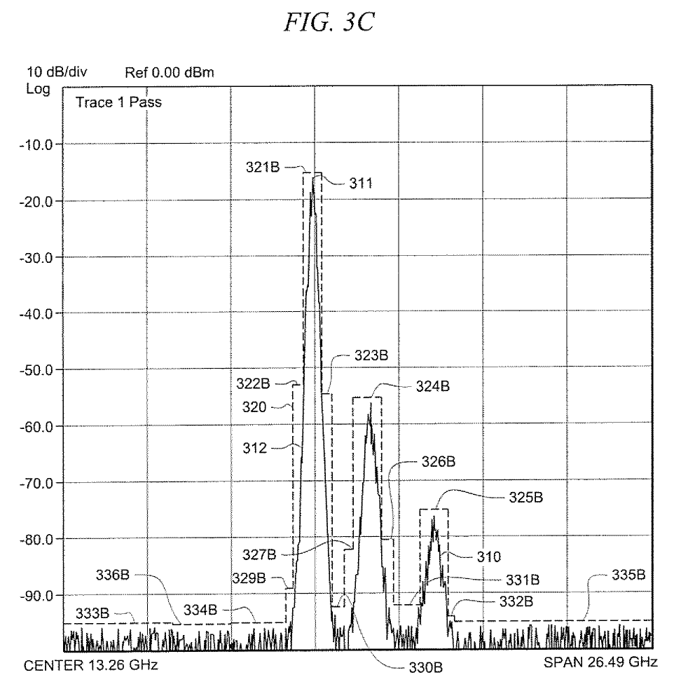

An exemplary test result trace is illustrated in FIGS. 3A-3C as trace 110. Specifically, trace 310 of FIGS. 3A-3C shows a graph of device output power as a function of input frequency in accordance with the foregoing example. Trace 310 is the plot of the dependent variable (output power) as a function of the independent variable (frequency) over a range of input test values. The independent parameter (here, frequency) is typically changed in small steps and measurements taken at each step to ensure that the measuring instrument captures all important features of a device's operation in the trace. Note that the foregoing is but one example of many possible measured relationships and is presented here for illustration purposes only.

The result of the foregoing measurement operation is a data set which comprises a plurality of individual data points, although when represented by trace 310 in FIGS. 3A-3C the points are closely spaced enough so as to appear as a continuous line. These data points are often referred to as buckets, wherein a bucket represents a value at which a measurement is taken and a small region around that point for which the measurement is considered to be valid. Depending upon the number of points selected for measurement (e.g., the sampling rate), the buckets will be larger or smaller. Where the measurement operation captures all the important features of a device's operation, the buckets selected will often be relatively small and thus the number of individual data points will be relatively large.

It should be appreciated that, although sample device 140 may have a predicted or desired response to the output test signal, the input test signal will likely include noise (e.g., thermal noise) and noise-like results (e.g., variations due to device manufacturing process variations, testing condition artifacts, etc.). A portion of such noise and noise-like results appear in trace 310 as jitter or random dependent variable fluctuations. That is, each measured point may have a value slightly different from an adjacent point due to small variations resulting from noise or noise-like results rather than the performance of the device being measured.

Processor 10, operating under control of test methodology 121 for example, can operate to remove some measurements that are deemed to be a result of random variations in the sampled data from the test results. One example of noise level determinations is made by observing samples at over-sample areas of the input variable. Thus, for a filter this over-sampling will occur at the flat top of the filter response. This then allows the system to estimate the noise levels since the actual signal should not be changing at that point so that changes in samples are then due to random variations, perhaps caused by noise jitter.

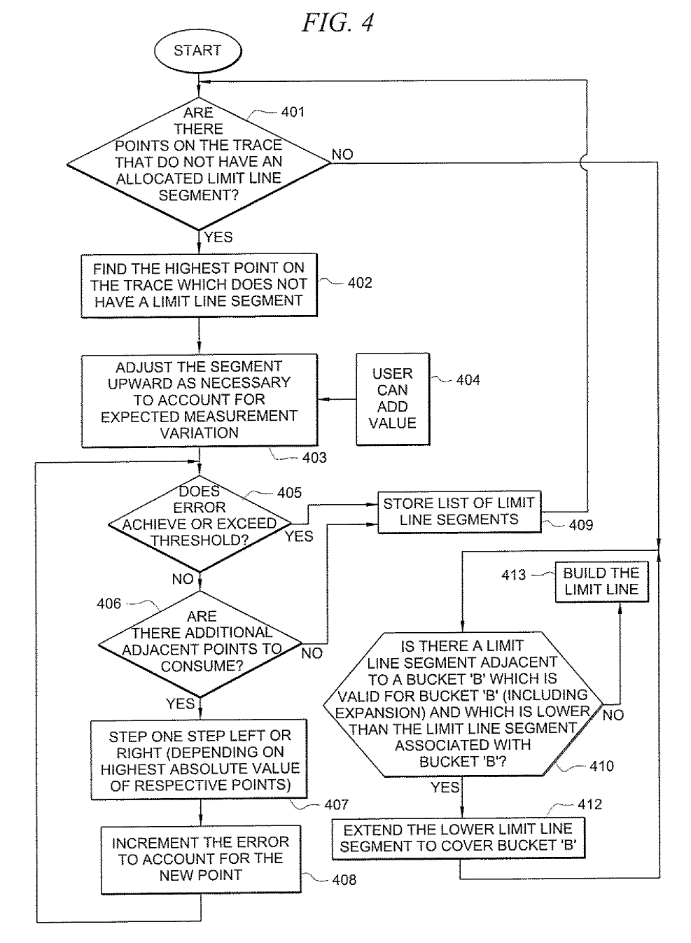

Having captured the test results (test results 122 as represented by trace 310), test specification generator 123 performs process 204 to autonomously or machine generate a test specification (test specification 124 as represented by limit line 320 of FIG. 3C), as may be used in acceptance testing, or otherwise analyzing, subsequent devices. Detail with respect to generation of test specifications according to embodiments of the invention is provided below with reference to FIG. 4. Further detail with respect to use of the generated test specifications with respect to devices under test (DUTs) is provided below with reference to FIG. 5.

When generating a limit line from a data set or trace for use in testing other similar devices, it is desirable to reduce the number of segments in the limit line, while preserving the essential features of the underlying trace and without loss of information content needed to achieve a valid test of subsequent devices. For example, it is important to remove from the resultant limit line variations caused by, for example, thermal noise without providing limit line variations which result in an unacceptable number of false positives and/or false negatives. This can be accomplished according to embodiments of the invention by evaluating whether there are sets of adjacent points whose variation can be sufficiently explained by measurement noise rather than by significant changes in the device performance as the independent parameter changes. Embodiments of the invention include replacement of the multiple measured points with a simple function, thus simplifying the data set while preserving features of interest. In one example, as described in detail below with respect to FIG. 4, a stair-stepped limit line is generated from a given trace with the limit line being always above the trace. However, embodiments of the invention operate to generate other configurations of limit lines, such as a limit line below the trace by taking the negative of all measured data, running the method, and taking the negative of the output.

A stair-step limit line may be created to ensure that the newly created limit line will pass the measurement on which it is built, as well as to ensure that the newly created limit line will accommodate expected thermal drift (or other expected changes) in the subsequent tests. One system and method is arranged to accept an arbitrary trace having at least one independent variable and at least one dependant variable and heuristically determine which groups of points can be represented by line segments without loss of significant information content. Using this determination, appropriate simplifications can be made to reduce the number of segments in the resulting trace.

Because this is a heuristic process (i.e., the methodology foregoes finding the optimal solution for an improvement in runtime) the resulting test specification will be correct in most cases. For the exceptional cases, the user retains the ability to adjust segments of the test specification to allow them to capture additional features of interest, or to offset the limit line by a fixed amount so as to allow additional or reduced margins For example, when a test is being conducted in a high (or low) ambient temperature the user may add or subtract an amount to compensate for known or anticipated measurement variations due to the temperature, or due to known or anticipated thermal drift.

FIG. 4 illustrates a flow diagram of operation of process 204 of FIG. 2 to provide autonomous or machine generation (i.e., automated techniques providing for generation) of a test specification using a test results data set according to an embodiment of the invention. Consistent with the foregoing spectrum analyzer example, the flow diagram of FIG. 4 will be discussed herein with reference to a single independent variable (here, frequency) and a single dependent variable (here, power) in order to simplify the discussion of the inventive concepts. Accordingly, the test specification generated will be discussed with reference to a limit line, although embodiments of the invention may provide different test specification configurations (e.g., limit plane, limit envelope defined by upper and lower limits, etc.). The test specification generated is typically in a somewhat simplified format, such that the test specification does not follow every diversion or feature in the trace. In the illustrated embodiment a stepped piece-wise linear limit line is generated, although other piece-wise segments may be utilized in simplifying the resulting test specification, if desired. For example, piece-wise sloping line segments may be utilized in a test specification generated according to embodiments of the invention.

Process 401 determines if there are buckets or points in the test results data set (test results 122 as represented by trace 310) that do not have a limit line segment of the test specification to be generated associated therewith. If there are no such points remaining (e.g., each test result data point has a portion of a piece-wise linear limit line associated therewith) then process 410 is entered as will be explained hereinafter. If there are points in the test results data set that do not have a limit line segment of the test specification to be generated associated therewith, then process 402 finds the highest point of the trace which does not currently have a limit line segment. For example, upon the initiation of process 204, point 311 (the highest point of trace 310) would be selected as the highest point not having a test specification limit line segment associated therewith because no point would yet have a test specification limit line segment associated therewith. Other criteria may be utilized in selecting points from which to work in generating piece-wise segments of a test specification, if desired. For example, where a limit line establishes an operational floor (i.e., the limit line is below the trace), a lowest point of the trace which does not currently have a limit line segment associated therewith may be identified for further processing.

Once this initial point for the particular limit line segment currently being generated is found, process 403 adjusts the corresponding point of the limit line segment being generated upwards as desired to account for expected measurement variations, such as, for example, thermal drift and device variations. This initial gap between the limit line segment and the trace may be established through various means. However, regardless of how the initial gap is chosen or what methodologies are used in selecting the gap, any amount used in establishing this initial gap between the limit line segment and the trace is typically selected so as to accommodate expected measurement variations in acceptable devices as well as expected measurement variations in testing parameters.

For example, prediction, experimentation, and/or simulation may be used to set an initial acceptance gap value used, such as to establish a gap by process 403 between point 311 of trace 310 and a segment of limit line 320 being generated by process 403 (here, line segment 321A). A user may select a value (e.g., difference of X dB between the selected point on the trace and the line segment of the limit line to be generated), a function (e.g., a difference of Y % between the selected point on the trace and the line segment of the limit line to be generate), etc. based upon the foregoing prediction, experimentation, simulation, etc. and input that information (process 404) for use in generating the test specification.

As another example, an initial acceptance gap value used, such as to establish a gap by process 403 between point 311 of trace 310 and a segment of limit line 320 being generated (line segment 321A), may be derived from or as a function of the test results data set according to embodiments of the invention. In establishing an expected measurement variation using a single input stimuli to output response data set or trace, embodiments of the present invention analyze measurement variation between adjacent buckets or data points within the data set. Such bucket-to-bucket variation has been found by the present inventors to provide a useful approximation of measurement variation. According to an embodiment of the invention, expected measurement variation (also referred to herein as “ε”) may be determined from bucket-to-bucket variation according to the following formula:

$$ExpectedMeasurement Variation = ɛ = \frac{1}{N} {\sum }_{i - 1}^{N} \vert trace [ i ] - trace [ i - 1 ] \vert \qquad ( 1 )$$

where N is the total number of adjacent buckets used in determining the expected measurement variation and trace[i] is the data at bucket or position i in the data set or on the trace. Alternative embodiments of the invention may utilize formulae, determined to be suitable for representing expected measurement variation, other than the foregoing example.

Equation (1) provides a determination of expected measurement variation by averaging the absolute value of the difference between each two adjacent buckets within a portion of the data set or trace. A number of buckets, such as from 2 buckets to all the buckets of the data set, may be selected from which to determine the expected measurement variation for the foregoing initial acceptance gap value. For example, for the first pass of process 403, wherein upon the initiation of process 204 point 311 is selected as the highest point not having a test specification limit line segment associated therewith, an expected measurement variation (ε) may be determined using a number of adjacent buckets to each side of point 311 (e.g., 20 buckets to the left of point 11 on trace 310 and 20 buckets to the right of point 311 on trace 310) to establish an amount to adjust the line segment of the limit line upward to account for expected measurement variation (the gap between point 311 of trace 310 and line segment 321A).

As discussed above, test specifications generated according to embodiments of the present invention are simplified to minimize resources utilized in their generation, use, storage, and editing. Rather than generating a limit line that closely follows all features of trace 310, the illustrated embodiment operates to generate a piece-wise linear, stepped limit line. In order to establish an extent to which a line segment of the limit line may be used to represent diversions or features in the trace, an error threshold is typically utilized according to embodiments of the invention. The error threshold may be determined as a function of the expected measurement variation. For example, the error threshold may be selected as a function of some multiple (threshold multiple) of the expected measurement variation (ε) and/or a weighting factor. According to an embodiment of the invention, the error threshold (also referred to herein as “τ”) may be determined from the expected measurement variation according to the. Following formula:

Error Threshold=τ=10(ε)√N (2)

where N is the number of buckets or points used in the expected measurement variation calculation, thus the square cost of N provides a weighting factor to the error threshold.

The error threshold is typically compared to a specification segment error representative of how closely (or not) the line segment of the limit line follows the corresponding portion of the trace. For example, for any line segment, or portion thereof the area between the line segment and corresponding portion of the trace may be used to determine a specification segment error for determining if the line segment is to be considered valid. Accordingly, a line segment of the limit line may be considered valid if the integrated error over the limit line is below the error threshold. However, to facilitate relatively long line segments which are valid in the presence of noise and noise-like results, embodiments of the present invention adjust the specification segment error calculation for the expected measurement error. Accordingly, embodiments of the invention determine specification segment error (also referred to herein as “σ”) according to the following formula:

$$Specification SegmentError = σ = {\sum }_{i = 0}^{b} max ( 0 , ( ( segment [ i ] - ɛ ) - trace [ i ] ) ) \qquad ( 3 )$$

where a and b are the endpoints of the line segment, or the portion thereof being considered, segment[i] is the data at bucket or position i on the line segment of the limit line, and trace[i] is the data at bucket or position i in the data set or on the trace.

According to the foregoing example, a line segment of the limit line is considered valid if the specification segment error is less than the error threshold. This relationship is represented by the following formula:

σ<τ (4)

Note that this definition of a valid line segment allows the test specification to be derived in such a way that the limit line follows the significant features of the trace, but is built on top of noise-like variation within the trace. A limit line which too closely tracks variations in the trace due to random jitter, such as is caused by thermal or other noise sources, would not be useful, since the measured values of the parts of a signal at the instrument noise floor will vary from measurement to measurement. The embodiment discussed builds a limit line which is on top of noise-like variation, so that subsequent measurements of the device are likely to fall within the region established by the limit line.

It should be appreciated that, in establishing measurement limits there is a tradeoff between false positives and false negatives. The error threshold shown above establishes a heuristic which will be reasonable for many users; many other heuristics are possible within the scope of this invention. The embodiment shown allows the user to make further adjustments if appropriate to a particular application.

Process 405 determines if the specification segment error (σ) for the line segment currently being generated meets or exceeds the error threshold (1). Each of equations (1)-(4) of the illustrative embodiment described above provide relatively simple mathematical functions that may readily be implemented by a variety of processors. Accordingly, process 405 performing these functions according to embodiments of the invention facilitates implementation on a variety of systems, including instruments having limited resources and processing power.

It should be appreciated that in a first pass of process 405 after having selected a highest point on the trace which did not have a limit line segment associated therewith, the foregoing specification segment error calculation may be made with respect to a line segment having a single point and a corresponding portion of the trace having a single point. However, as more adjacent buckets are “consumed” in generating a line segment of the limit line through iterative operation as described below, the number of buckets in each will increase.

If process 406 determines that the specification segment error (σ) does not meet or exceed the error threshold (τ), then additional buckets or points of trace 310 may be “consumed” in creating a longer line segment of the limit line. That is, for each adjacent point of the trace analyzed a corresponding point is added to the line segment of the test specification being generated and, if the specification segment error (σ) does not meet or exceed the error threshold (τ), the incrementally longer line segment is considered valid and the bucket or point of trace 310 has a valid line segment associated therewith, thus having been “consumed”. Accordingly, process 406 of the illustrated embodiment determines if there are any additional adjacent buckets or points to consume. If there are no more adjacent buckets to consume, process 409 stores the generated line segment (e.g., a currently generated one of line segments 321A-336A) in test specification 124 and processing returns to process 401 to determine if any more buckets remain on trace 310 for which a line segment has not yet been generated. If at process 406 there are more adjacent buckets to consumer then process 407 steps one bucket left or right (e.g., whichever has a higher absolute value) and process 408 increments the length of line segment being generated as well as the specification segment error (σ) to account for the new bucket. Process 405 is repeated to determine if the incremented line segment remains valid (σ<τ). These iterations continue until process 406 determines that there are no additional points to consume (σ≧τ).

Accordingly, if the specification segment error (σ) meets or exceeds the error threshold (τ), σ≧τ then the particular line segment being generated has “consumed” all of the buckets of the trace which may be represented by this piece-wise linear segment of the test specification. Accordingly, process 409 stores the generated line segment (e.g., a currently generated one of line segments 321A-336A), less the last bucket analyzed which resulted in the error threshold being exceeded, in test specification 124 and processing returns to process 401 to determine if any more buckets remain on trace 310 for which a line segment has not yet been generated. Alternative embodiments may include the last bucket analyzed which caused the line segment to no longer be valid as part of the line segment so as to provide an expansion of the line segment, such as to be more acceptable to measurement variation. However, a preferred embodiment, as described below, operates to provide expansion of the line segment at a later point in the process, and thus the last bucket analyzed which caused the line segment to no longer be valid is not be included as part of the line segment according to preferred embodiments of the invention,

If at process 401 it is again determined that there are buckets or points in the test results data set (test results 122 as represented by trace 310) that do not have a limit line segment of the test specification associated therewith, process 402 again finds the highest point of the trace which does not currently have a limit line segment (e.g., point 312) and another line segment (e.g., line segment 322A) is generated through iterative operation of processes 404-408 as described above. However, if there are no such points remaining (e.g., each test result data point has a portion of the piece-wise linear limit line associated therewith) then process 410 is entered.

At this stage of the operation of the flow diagram of FIG. 4, a plurality of limit line segments (egos line segments 312A-336A) have been generated which together correspond to all buckets or points of trace 310. The limit line segments are perhaps wider than needed due to the use of a “greedy” method in the foregoing example. That is, as long as a bucket or point along the trace could be represented by a line segment then currently being generated without the specification segment error (σ) meeting or exceeding the error threshold (τ) that bucket was included in that line segment. Such a “greedy” method provides a generated limit line having a reduced or minimized number of piece-wise segments, each providing an acceptable error with respect to the trace, thereby facilitating its use even with respect to instruments having limited resources.

After it is determined in process 401 that all buckets or points of trace 310 have a line segment associated therewith, processing according to the illustrated embodiment proceeds to process 410 wherein a line segment expansion methodology is implemented. Process 410, operating on line segments 321A-336A stored in test specification 124, determines if any given bucket b is associated with a limit line segment (e.g., line segment 324A) which is adjacent to a bucket associated with a lower limit line segment (e.g., line segment 326A). If it is, then bucket b is added to the lower limit line segment by process 410, thereby providing expansion of the lower limit line segment for mitigation of the foregoing greedy method. The extension of line segment 326A to include one or more buckets originally associated with line segment 324A is shown in FIG. 3B, wherein line segment 326B is extended as compared to line segment 326A and line segment 324B is reduced as compared to line segment 324A. It should be appreciated than not all line segments, and in some cases no line segments, will be modified through operation of process 410.

Additionally or alternatively, to account for drift in the method's ability to measure the independent parameter, embodiments of the present invention provide line segment expansion so that a limit line peak is always wider (e.g., at least one bucket) than the peak in the measured data. To accomplish such an expansion, process 410 may analyze each line segment associated with a peak in 312 to determine if the limit line associated therewith extends at least one bucket beyond the bucket associated with the peak in each direction. This line segment expansion will provide protection against small measurement variations causing, a shift in the independent variable by less than one bucket.

The foregoing line segment expansion process can be done in order N times by sweeping left and then right through the measured data, with the resultant modified (extended/reduced) line segments (e.g., line segments 312B-336B) being stored in test specification 124 by process 412. Although the forgoing example provides for a one-bucket line segment expansion of various line segments, alternative embodiments, such as those using a different measurement system, may allow a larger expansion (e.g., multiple bucket expansion).

When process 410 determines that no additional adjustments need to be made, process 413 of the illustrated embodiment builds limit line 320 from the line segments stored in test specification 124. For example, in the foregoing example of a stepped, piece-wise linear limit line, vertical line segments may be added to connect the generated line segments, as shown in FIG. 3C, to thereby provide continuous limit line 320. As part of the generation of the test specification, process 413 may operate to make any necessary or desirable adjustments (e.g., using data input at process 404) to the test specification. For example, a specification might call for production devises to be within a certain range of a known good device. Such adjustment could be made by process 413 subsequent to the automatic extraction of significant features as described above.

Referring again to FIG. 1B, test facility 100 applying the above generated test specification to a device under test is shown. Specifically, DUT 150 is being tested against limit line 320, stored in test specification 124, under control of test methodology 121 and acceptance methodology 125. The flow diagram of FIG. 5 shows further detail with respect to the foregoing operation of test facility 100. Specifically, FIG. 5 shows operation of test facility 100 as performed by processor 110 operating under control of control instructions of test methodology 121 and acceptance methodology 125.

Directing attention to FIG. 5, test methodology 121 operable in a device test mode performs process 501 to determine if a device, such as DUT 150 is ready for testing, DUT 150 typically comprises one of a plurality of devices for which performance evaluation is to be performed by test facility 100 using acceptance methodology 125 and test specification 124. If it is determined at process 501 that no device is ready for testing processing may stop (e.g., “do nothing”) or may continue to monitor for a device for testing. If it is determined at process 501 that a device is ready for testing, processing according to the illustrated embodiment proceeds to process 502.

Process 502 of test methodology 121 retrieves the proper test parameters for conducting the desired testing. Process 503 then (optionally) determines if any adjustments are to be made to the retrieved test parameters to anticipate variations in test results. These adjustments could be, for example, to compensate for temperature and/or altitude differences between when the golden device was sampled and the temperature and/or altitude at the time of subsequent testing. Adjustments can be made for any number of reasons at the discretion of the user, if desired. Process 504 controls any such adjustments which can be made at the time of the testing, as shown, or at any time before the testing.

Process 505 of test methodology 121 causes an output test signal in accordance with test parameters of test methodology 121 to be provided to DUT 150. The output test signal provides a same range (as may be modified by adjustments at process 504) of at least one independent variable, such as frequency, voltage, current, power, data rate, modulation scheme, noise injection, amplitude, etc., to DUT 150 as was provided to sample device 140.

Process 506 of test methodology 121 captures an output of DUT 150 as the input test signal and stores the test results data set in test results 122. In the foregoing example of a spectrum analyzer, the input test signal may comprise a range of power resulting from the sweep or series of frequencies of the output test signal. Accordingly, the input test signal may be represented as a trace of the above mentioned at least one independent variable at different values and the at least one dependent variable at corresponding values

The data set resulting from operation of test methodology 121 is compared against the test specification stored in test specification 124 by acceptance methodology 125 at process 507. For example, in the above example where an upper test limit is established by limit line 320, trace representing the data set obtained from DUT 150 may be analyzed by acceptance methodology 125 to determine if the trace exceeds limit line 320 at any point. If the data set obtained from DUT 150 is determined not to be within the test specification at process 508, DUT 150 is rejected at process 509. However, if the data set obtained from DUT 150 is determined to be within the test specification at process 508, DUT is accepted at process 510. Thereafter, processing may return again to process 501 for testing of additional devices.

Although the foregoing example was described with reference to acceptance methodology 125 operating to make a determination as to accepting/rejecting a device under test, the use of such an acceptance methodology may be omitted according to embodiments of the invention. For example, a trace representing the data set obtained from DUT 150 may be displayed upon a monitor of test facility 100 along with limit line 320 for analysis by a user thereof.

Note that while the test facility shown in FIG. 1A and 1B, used with respect to generating a test specification and applying the test specification to devices under test respectively, are shown as being the same system, they need not be. The autonomous or machine generation of the test specification can be performed by a device different than the test facility that is used to test the DUTs, and the test specification can be, for example, transmitted to the test facility for storage in memory therein, or the test specification can be accessed remotely during or before testing.

Although the foregoing example embodiment has been described with respect to generating a test specification using a sample device and using the test specification for testing other devices, the concepts of the invention are not limited to such an embodiment. For example, a test specification generated according to the present invention may be utilized in later testing the same sample device for continued acceptable performance.

It should be appreciated that, although embodiments of the present invention are adapted to facilitate generation, editing, and/or use of a test specification upon instruments or other systems having limited resources, the concepts of the present invention provide advantages with respect to generation, editing, and/or use of test specifications on any number of platforms. Accordingly, rather than generating a test specification within an instrument as shown above, embodiments of the present invention may utilize a computer platform (e.g., a personal computer or workstation) not directly utilized in device testing for generating a test specification as described herein.

Moreover, the various data sets, such as test results and test specifications, and/or control methodologies, such as test methodologies, test specification generators, and acceptance methodologies, need not be stored in any particular device or system according to the concepts of the present invention. For example, a test specification may be generated by a first system (whether a test facility, computer system, etc.) and stored at a central location, such as via a wired or wireless network connection. This test specification may be accessed, such as via a wired or wireless network connection, by a test facility at or before a time of testing one or more devices, if desired. Similarly, various devices, such as a plurality of test facilities, may communicate with one another, such as via wired or wireless network connections, to share data sets and/or control methodologies. Other topologies, such as server/client, master/slave, etc., may additionally or alternatively be utilized as appropriate or desired.

Although embodiments of the present invention have been described herein to generate test specifications from a single data set (e.g., a single set of test results from a sample device), concepts of the present invention are applicable with respect to generating test specifications from a plurality of data sets (e.g., a plurality of test results from a sample device or test results from a plurality of sample devices). For example, where the data set provides a one dimensional data compilation (e.g., only a dependent variable is present in a test results data set), application of the above described expected measurement variation, error threshold, and specification segment error may be utilized with respect to corresponding buckets or data points between the plurality of data sets.

It should be appreciated that one or more of the foregoing expected measurement variation, error threshold, and specification segment error may be utilized outside of generation of test specifications. For example, these parameters may be utilized in comparing a test results data set of a DUT to a test specification, such as to determine acceptance of the device, to determine a level of performance of the DUT, etc. Such parameters may be unaltered as between generation of a test specification and their use in comparing a DUT data set to the test specification, or they may be altered as desired. For example, the error threshold may be adjusted slightly as between generation of a test specification and comparing a DUT data set to the test specification in order to accommodate variations in the tests.

Test specifications generated according to an embodiment of the invention described above are piece-wise linear due to their association with a two dimensional test data set. Embodiments of the present invention may generate other test specification configurations, such as any piece-wise constant configuration (e.g., piece-wise planar when a three dimensional test data set is present) or other contours.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for establishing a test specification, said method comprising:
capturing a single test results data set from a test of a sample device, said single test results data set providing at least one independent variable and at least one dependent variable over a range of test values; and
machine generating from said single test results data set a test specification for testing subsequent devices over said range of test values.

2. The method of claim 1, wherein said machine generating said test specification comprises:
determining an expected measurement variation as a function of data point to data point variation in said single test results data set.

3. The method of claim 2, wherein said determining said expected measurement variation comprises:
averaging an absolute value of a difference between each two adjacent data points within a portion of said single test results data set.

4. The method of claim 2, wherein said machine generating said test specification further comprises:
determining an error threshold as a function of said expected measurement variation;
generating a piece-wise constant segment of said test specification; and
determining if said piece-wise constant segment is to be considered valid for use in said test specification through reference to said error threshold.

5. The method of claim 4, wherein said determining said error threshold comprises:
multiplying said expected measurement variation by a threshold factor and a weighting factor.

6. The method of claim 4, wherein said determining if said piece-wise constant segment is to be considered valid comprises:
determining a specification segment error as a function of an area between a portion of a trace representing data points of said single test results data set corresponding to said piece-wise constant segment of said test specification and said piece-wise constant segment of said test specification.

7. The method of claim. 4 wherein said piece-wise constant segment of said test specification comprises a piece-wise linear segment of said test specification.

8. The method of claim 1, wherein said machine generating said test specification comprises:
generating a plurality of piece-wise constant segments of said test specification.

9. The method of claim 87 wherein said generating said plurality of piece-wise constant segments of said test specification comprises:
initiating a new piece-wise constant segment of said test specification with a data point of said single test specification having no piece-wise constant segment of said test specification associated therewith;
associating adjacent data points of said single test results data set with said new piece-wise constant segment of said test specification until an error threshold is met or exceeded;
repeating said initiating and said associating until each data point of said single test results data set has a piece-wise constant segment of said test specification associated therewith.

10. The method of claim 9, wherein said generating said plurality of piece-wise constant segments of said test specification further comprises:
determining, for a data point associated with a first piece-wise constant segment of said test specification which is adjacent to a data point associated with a second piece-wise constant segment of said test specification, if said second piece-wise constant segment of said test specification is valid for said data point associated with said first piece-wise constant segment of said test specification;
associating said data point associated with said first piece-wise constant segment of said test specification with said second piece-wise constant segment of said test specification to thereby expand said second piece-wise constant segment of said test specification.

11. The method of claim 1 wherein said test specification comprises a limit line.

12. The method of claim 1, wherein said capturing and said machine generating are performed by an instrument utilized to test devices.

13. The method of claim 12, wherein said instrument is selected from the group consisting of a spectrum analyzer, an oscilloscope, and a network analyzer.

14. A system for generating a test specification, said system comprising:
a processor;
a test methodology operable upon said processor to perform a test of a device in which at least one independent variable is controlled over a range of test values;
a test results data set including a plurality of data points for said at least one independent variable and at least one dependent variable over said range of test values, wherein said test results data set is captured through operation of said test methodology; and
a test specification generator operable upon said processor to access said test results data set and autonomously generate a test specification adapted to accommodate expected measurement variation as determined by said test specification generator from said test results data set.

15. The system of claim 14, wherein said test results data set is a single test results data set from a test of a sample device.

16. The system of claim 14, further comprising:
a test specification generated by said test specification generator.

17. The system of claim 16, wherein said test specification comprises:
a plurality of piece-wise constant segments.

18. The system of claim 17, wherein said piece-wise constant segments are piece-wise linear segments.

19. The system of claim 14, wherein test specification generator comprises:
an expected measurement variation value determined as a function of data point to data point variation in said test results data set.

20. The system of claim 19, wherein said test specification generator further comprises;
an error threshold value determined as a function of said expected measurement variation.

21. The system of claim. 20, wherein said test specification generator further comprises:
a specification segment error value determined as a function of an area between a portion of a trace representing data points of said test results data set corresponding to a segment of said test specification and said segment of said test specification.

22. A method for establishing a limit line for a particular device; said method comprising:
providing a test results data set from a test sequence administered to said particular device;
determining groups of points along said test results data set that can be represented by line segments without loss of information content regarding fundamental device operating characteristics; and
generating a limit line using said line segments.

23. The method of claim 22, wherein said test results data set represents the output of a variable dependent upon an independent variable input.

24. The method of claim 22, wherein said determining groups of points uses said test results data set as an only test results data set for determining said groups of points that can be represented by line segments.

25. The method of claim 22, wherein said determining groups of points comprises:
determining an expected measurement variation as a function of data point to data point variation in said test results data set.
